(19) United States
(12) Patent Application Publication
(10) Pub. No.: US 2025/0187081 A1
(43) Pub. Date: Jun. 12, 2025

(54) POLYCRYSTALLINE DIAMOND ELEMENT INCLUDING AT LEAST ONE LEACHING FEATURE, CUTTING TOOL INSERTS AND SYSTEMS INCORPORATING SAME, AND RELATED METHODS

(71) Applicant: US Synthetic Corporation, Orem, UT (US)

(72) Inventors: Regan Leland BURTON, Saratoga Springs, UT (US); Edwin Sean COX, Spanish Fork, UT (US); Jason CARDELL, Orem, UT (US); Verl DALLIN, Spanish Fork, UT (US)

(21) Appl. No.: 18/844,758

(22) PCT Filed: Feb. 27, 2023
(86) PCT No.: PCT/US2023/013960

§ 371 Date: Sep. 6, 2024

Related U.S. Application Data
(60) Provisional application No. 63/318,663, filed on Mar. 10, 2022.

(51) Int. Cl. B23B 27/14; B23K 26/352

(52) U.S. Cl. CPC B23B 27/148; B23K 26/352; B23B 2226/315

(57) ABSTRACT

At least one embodiment of a polycrystalline diamond element that may be used in machining various material includes a polycrystalline diamond body having a plurality of bonded diamond grain defining a plurality of interstitial regions, at least some of the plurality of interstitial regions at least partially occupied and/or previously occupied by at least one interstitial constituent. The polycrystalline diamond element also includes at least one leaching feature within the polycrystalline diamond body positioned and configured to reduce leaching cycle time of the at least one interstitial constituent.

### CROSS-REFERENCE TO RELATED APPLICATION(S)

This application claims priority to U.S. Provisional Patent Application No. 63/318,663 filed on Mar. 10, 2022, the disclosure of which is incorporated herein, in its entirety, by this reference.

### BACKGROUND

Cutting tools are conventionally used in machining operations to remove material and form desired shapes and surfaces of a given object. For example, milling is a machining process wherein material is progressively removed in the form of “chips” to form a shape or surface from a given volume of material-often referred to as a work piece. This may be accomplished by feeding the work piece into a rotating cutting tool (or vice-versa), often in a direction that is perpendicular to the axis of rotation of the cutting tool. Various types of cutters may be employed in milling operations, but most cutting tools include a body and one or more teeth (or cutting elements-which may be brazed or mechanically attached to the body) that cut into and remove material from the work piece as the teeth of the rotating cutter engage the work piece.

Nearly any solid material may be machined, including metals, plastics, composites and natural materials. Some materials are more easily machined than other types of materials, and the type of material being machined may dictate, to a large extent, the process that is undertaken to machine the work piece, including the choice of cutting tool. For example, titanium and titanium alloys, while exhibiting a number of desirable mechanical and material characteristics, are notoriously difficult to machine.

While there are numerous reasons for the difficulty in milling titanium materials, some of them not entirely understood, some reasons may include its high strength, chemical reactivity with cutter materials, and low thermal conductivity. These characteristics tend to reduce the life of the cutter. Additionally, the relatively low Young's modulus of titanium materials is believed to lead to “chatter” in the cutting tool, often resulting in a poor surface finish of a machined work piece. Further, the “chips” that are typically formed in machining processes such as milling are not typically small broken chips but, rather, long continuous chips which may become tangled in the machinery, posing a safety hazard and making it difficult to conduct automatic machining of titanium materials.

While there have been various attempts to provide cutting tools that provide desirable characteristics for machining various materials, including normally difficult-to-machine materials such as titanium, there is a continued desire in the industry to provide improved cutting tools for machining of a variety of materials and for use in a variety of cutting processes.

### SUMMARY

Embodiments disclosed herein relate to polycrystalline diamond elements, such as elements that may be used in the machining of various materials. In some embodiments, a polycrystalline diamond element may include a polycrystalline diamond body having a plurality of bonded diamond grain defining a plurality of interstitial regions, at least some of the plurality of interstitial regions at least partially occupied and/or previously occupied by at least one interstitial constituent and at least one leaching feature within the polycrystalline diamond body positioned and configured to facilitate leaching of the at least one interstitial constituent. In some embodiments, the polycrystalline diamond element may include at least one of a bearing or a cutting tool insert.

In some embodiments, a cutting tool insert may include a polycrystalline diamond body including a plurality of interstitial regions, at least some of the plurality of interstitial regions at least partially occupied and/or previously occupied by at least one interstitial constituent. The cutting tool insert may further include at least one leaching feature defined by a portion of the body. The leaching feature may reduce the cross-sectional area of the body to reduce leaching cycle time of the at least one interstitial constituent.

In some embodiments, a method of forming a cutting tool insert may include providing a polycrystalline diamond body having an exterior surface, the polycrystalline diamond body including a plurality of bonded diamond grains defining a plurality of interstitial regions. The method may further include applying laser energy to the polycrystalline diamond body effective to remove a portion of the polycrystalline diamond body by layered ablation of the polycrystalline diamond body.

Various elements, components, features or acts of one embodiment described herein may be combined with elements, components, features or acts of other embodiments without limitation.

### BRIEF DESCRIPTION OF THE DRA WINGS

The drawings illustrate various embodiments of the invention, wherein common reference numerals refer to similar, but not necessarily identical, elements or features in different views or embodiments shown in the drawings.

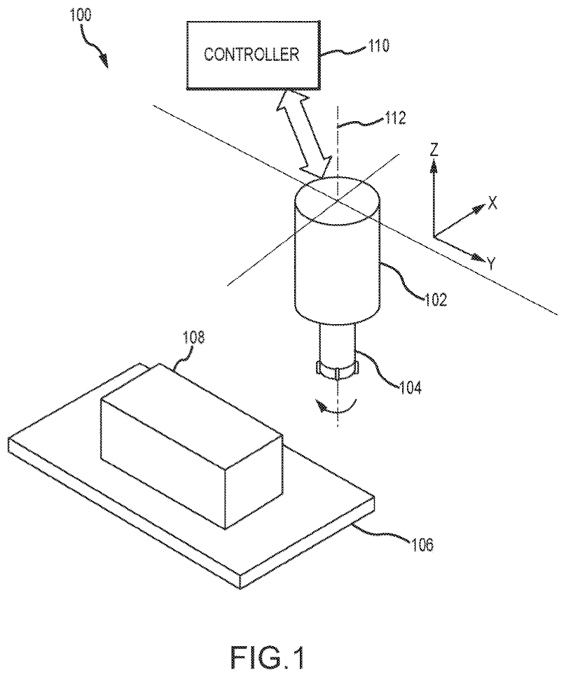

FIG. 1 is a schematic drawing showing a milling operation according to one embodiment of the present disclosure;

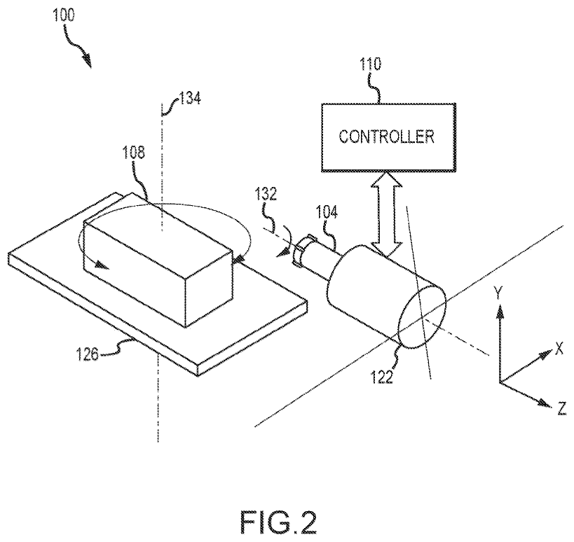

FIG. 2 is a schematic drawing showing a milling operation according to another embodiment of the present disclosure;

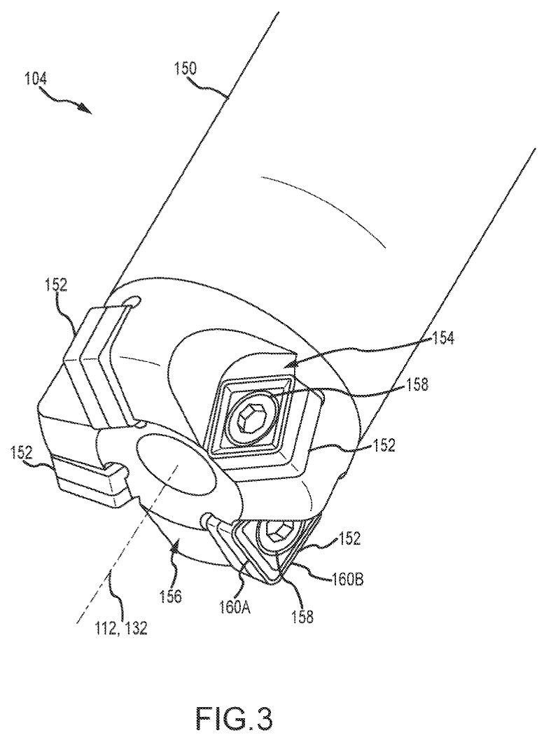

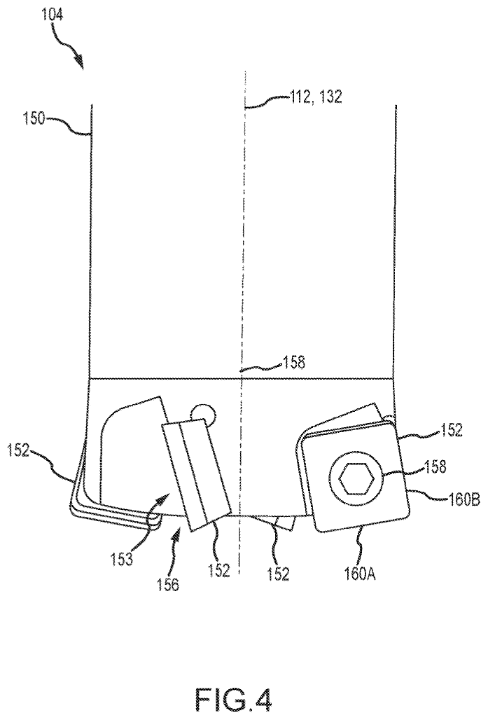

FIGS. 3 and 4 are perspective and side views, respectively, of a cutting tool in accordance with an embodiment of the present disclosure;

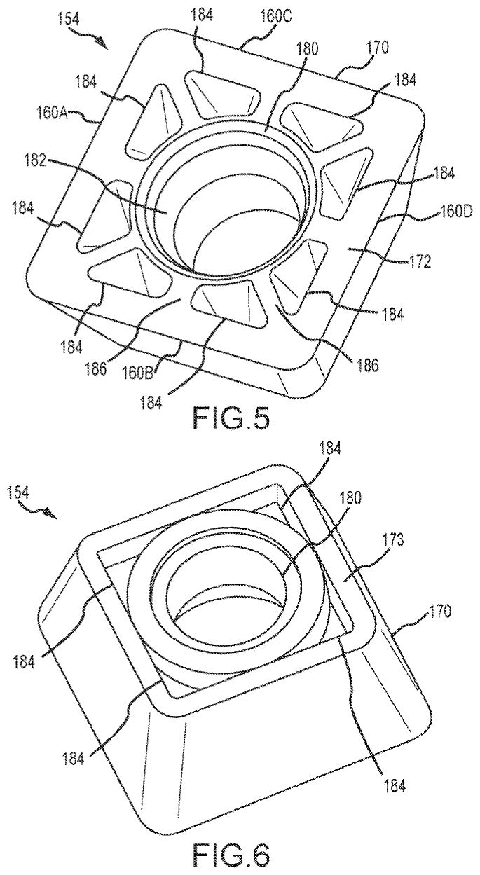

FIG. 5 is a lower perspective view of a cutting tool insert according to an embodiment of the present disclosure;

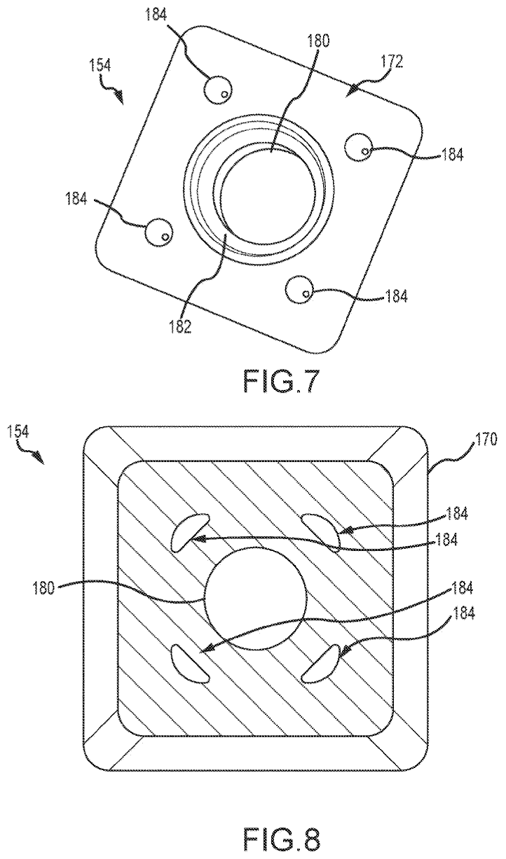

FIG. 6 is an upper perspective view of a cutting tool insert according to an embodiment of the present disclosure;

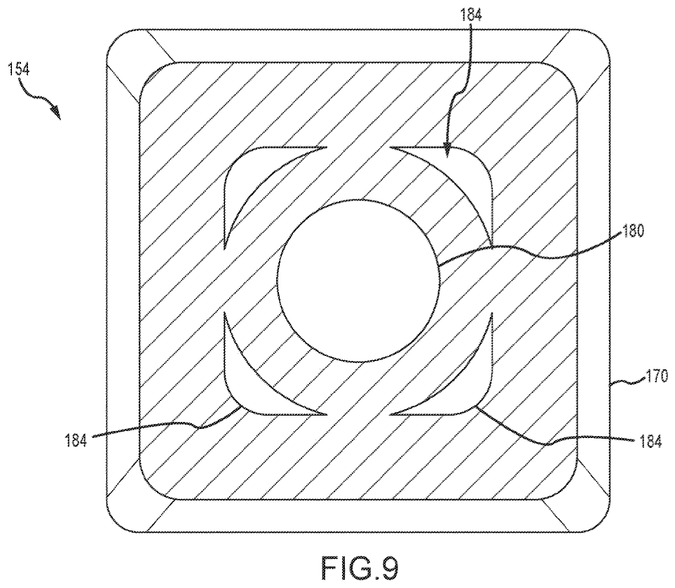

FIG. 7 is a lower perspective view of a cutting tool insert according to an embodiment of the present disclosure;

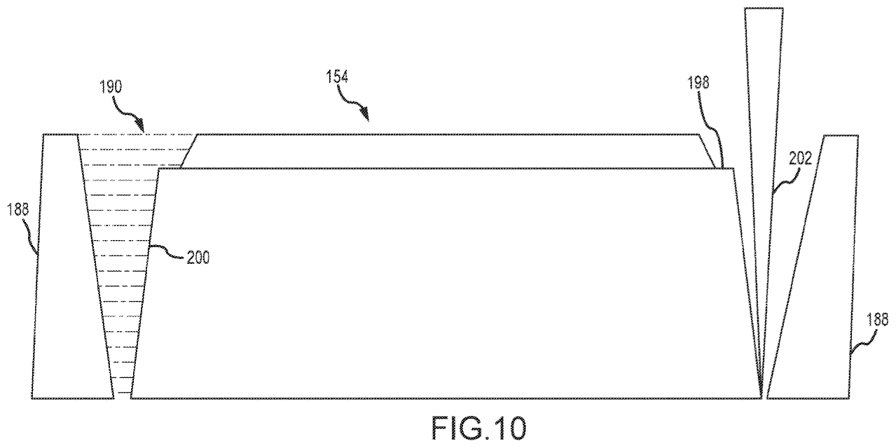

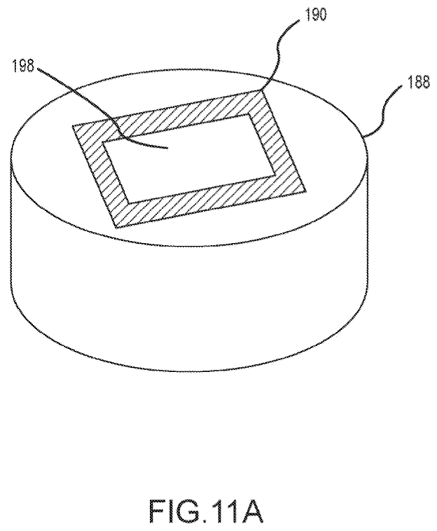

FIGS. 8 and 9 are cross-sectional views of a cutting tool insert according to an embodiment of the present disclosure;

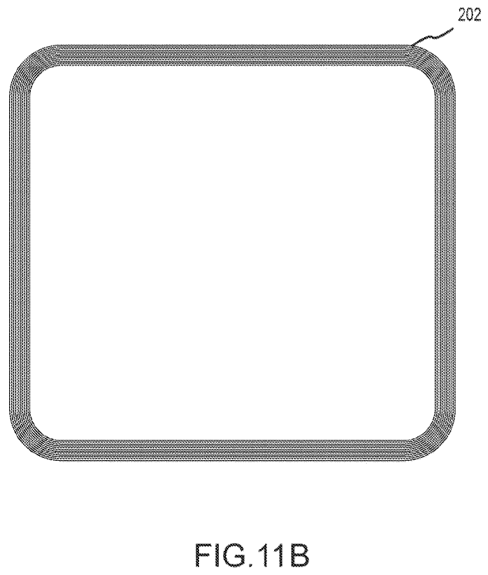

FIG. 10 is a side view of a cutting tool insert being formed by laser ablation, according to an embodiment of the present disclosure;

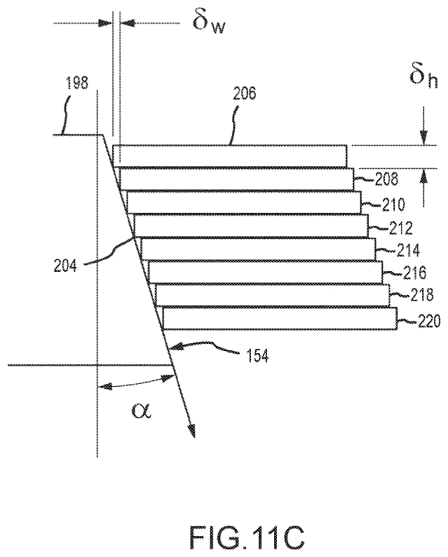

FIG. 11A is an upper perspective view of a polycrystalline diamond element insert blank for forming a cutting tool insert by laser ablation, according to an embodiment of the present disclosure;

FIG. 11B is a plan view of concentric laser trajectories for forming a laser ablation layer around a cutting tool insert, according to an embodiment of the present disclosure; and

FIG. 11C is a schematic view of a cutting tool insert being formed by laser ablation, according to an embodiment of the present disclosure.

### DETAILED DESCRIPTION

Embodiments of the disclosure relate to polycrystalline diamond elements, such as elements used in cutting tools. Such cutting tools may be used in machining processes, including milling, drilling, turning as well as variations and combinations thereof. The cutting tools may be used in shaping, forming and finishing a variety of different materials, including materials that are often difficult to machine, including, for example, titanium, titanium alloys and nickel based materials.

Referring to FIG. 1, an example of the operation of a vertical milling machine (VMM) 100 is schematically shown. The VMM 100 includes a spindle 102 having a cutting tool 104 removably coupled therewith in accordance with an embodiment of the present disclosure. The VMM 100 also includes a table 106 on which a work piece 108 is placed. A CNC (computer numerically controlled) controller 110 is in communication with the spindle 102 and may control the action of the spindle 102 and/or the table 106. While not expressly shown in FIG. 1, a frame may couple several of the components together (e.g., the spindle 102 and the table 106). The spindle 102 is configured to rotate the cutting tool 104 about an axis 112 and to also move the cutting tool 104 in the X, Y and Z directions relative to the table 106 and associated work piece 108.

As noted above, the controller 110 is in communication with the spindle 102 and configured to control various operations of the VMM 100. For example, the controller 110 may be configured to control the rotational speed of the cutting tool 104 and also move the spindle 102 or table 106 (and, thus, the cutting tool 104) in specified directions along the X-Y-Z axes at a desired “feed rate” relative to the work piece 108. Thus, the controller 110 may enable the cutting tool 104 to remove material from the work piece 108 so as to shape it and provide a desired surface finish to the work piece 108 as will be appreciated by those of ordinary skill in the art.

Referring to FIG. 2, an example of the operation of a horizontal milling machine (HMM) 120 is schematically shown. The HMM 120 includes a spindle 122 having a cutting tool 104 removably coupled therewith in accordance with an embodiment of the present disclosure. The HMM 120 also includes a table 126 on which a work piece 108 is placed. The table 126 may be vertically oriented. A CNC controller 110 is in communication with the spindle 122 and table 126 and controls the action of the spindle 122. In one embodiment, the controller 110 may also be in communication with the table 126 and/or spindle 122 to displace one or both in a desired direction, respectively, as discussed below. While not expressly shown in FIG. 2, a frame may couple several of the components together (e.g., the spindle 122 and the table 126). The spindle 122 is configured to rotate the cutting tool 104 about an axis 132 and to also move the cutting tool 104 in the X, Y and Z directions relative to the table 126 and the associated work piece 108. Additionally, the table 126 may be configured to rotate about a B-axis 134, which is substantially orthogonal to the rotational axis 132. In one embodiment, the controller 110 may be configured to control the rotational speed of the cutting tool 104, displace the spindle 122 (and, thus, the cutting tool 104) in a specified direction and at a desired “feed rate” relative to the work piece 108, and also rotate the table 126 (and thus the work piece 108). Thus, the controller 110 may enable the cutting tool 104 to remove material from the work piece 108 so as to shape it and provide a desired surface finish to the work piece 108 as will be appreciated by those of ordinary skill in the art.

It is noted that the milling machines 100 and 120 described with respect to FIGS. 1 and 2 are merely examples, and that a variety of other machining systems are contemplated as incorporating a cutting tool such as is described in further detail below for use in a variety of machining operations.

Referring now to FIGS. 3 and 4, a cutting tool 104 is shown having a tool body 150 and a plurality of polycrystalline diamond elements 152, according to an embodiment. The polycrystalline diamond elements 152 may include at least one of a bearing or a cutting tool insert. The polycrystalline diamond elements 152 may include a polycrystalline diamond body comprising a plurality of bonded diamond grain defining a plurality of interconnected interstitial regions, at least some of the plurality of interstitial regions at least partially occupied by at least one interstitial constituent.

Various materials may be used in forming the body 150 of the cutting tool 104 including various metals and metal alloys. In some embodiments, the body 150 may comprise an aluminum or aluminum alloy material. Other materials that may be used in forming the tool body 150 include, without limitation, steel and steel alloys (e.g. stainless steels), nickel and nickel alloys, titanium and titanium alloys, tungsten and tungsten alloys, tungsten carbide and associated alloys, and other metals.

The polycrystalline diamond elements 152 may be disposed in pockets 153 formed in an end or region of the body 150. In some embodiments, the cutting tool insert may be removably coupled with the tool body 150 such as by a fastener 158. The fastener 158 may pass through a hole centered in the polycrystalline diamond body. In some embodiments, the polycrystalline diamond elements 152 may be indexable relative to the tool body 150. Thus, for example, as one face 160A or edge of a given polycrystalline diamond element 152 becomes worn or damaged, the element 152 may be rotated relative to the tool body 150 such that a new face or edge 160B may be presented to a work piece for the cutting and removal of material therefrom. In some embodiments, the polycrystalline diamond elements 152 may be removably coupled with the body 150 using clamping mechanisms. In some embodiments, the polycrystalline diamond elements 152 may be coupled with the body 150 by brazing or other material joining techniques.

In some embodiments, the polycrystalline diamond elements 152 (e.g. cutting elements) may comprise superhard, super abrasive polycrystalline materials. For example, referring to FIGS. 5-6 the polycrystalline diamond elements 152 may include a cutting tool insert 154 that may include a superhard, super abrasive body 170 defining a top surface 172 a bottom surface 173 opposite the top surface 172. In some embodiments, the cutting tool insert 154 may comprise a polycrystalline diamond compact (“PDC”) including a polycrystalline diamond (“PCD”) body.

The PCD body 170 includes a plurality of directly bonded-together diamond grains exhibiting diamond-to-diamond bonding therebetween (e.g., sp3 bonding), which define a plurality of interstitial regions. A portion of, or substantially all of, the interstitial regions of the PCD body 170 may include a metal-solvent catalyst or a metallic infiltrant disposed therein. For example, the metal-solvent catalyst or metallic infiltrant may be selected from iron, nickel, cobalt, or alloys of the foregoing. In some embodiments, the PCD body 170 may further include thermally-stable diamond in which the metal-solvent catalyst or metallic infiltrant has been partially or substantially completely depleted from a selected surface or volume of the PCD body 170, such as via an acid leaching process.

In some embodiments, PDCs which may be used as the polycrystalline diamond elements 152 may be formed or sintered in an HPHT process. For example, diamond particles may be subjected to an HPHT process to sinter the diamond particles to form the PCD body 170. The temperature of the HPHT process may be at least about 1000° C. (e.g., about 1200° C. to about 1600° C.) and the cell pressure, or the pressure in the pressure-transmitting medium (e.g., a refractory metal can, graphite structure, pyrophyllite, etc.), of the HPHT process may be at least 4.0 GPa (e.g., about 5.0 GPa to about 12 GPa or about 7.5 GPa to about 11 GPa) for a time sufficient to sinter the diamond particles.

In some embodiments, the diamond particles may exhibit an average particle size of about 50 μm or less, such as about 30 μm or less, about 20 μm or less, about 10 μm to about 20 μm, about 10 μm to about 18 μm, about 12 μm to about 18 μm, or about 15 μm to about 18 μm. In some embodiments, the average particle size of the diamond particles may be about 10 μm or less, such as about 2 μm to about 5 μm or submicron. In some embodiments, the diamond particles may exhibit multiple sizes and may comprise, for example, a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the mass of diamond particles may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm. 4 μm, 3 μm, 2 μm, 1 μm, 0.9 μm, 0.8 μm, 0.7 μm, 0.6 μm, 0.5 μm, less than 0.5 μm, 0.4 μm, 0.3 μm, 0.2 μm, 0.1 μm, less than 0.1 μm). For example, in one embodiment, the diamond particles may include a portion exhibiting a relatively larger size between about 10 μm and about 40 μm and another portion exhibiting a relatively smaller size between about 0.5 μm and 4 μm. In some embodiments, the diamond particles may comprise three or more different sizes (e.g., one relatively larger size and two or more relatively smaller sizes), without limitation. The PCD body 170 so-formed after sintering may exhibit an average diamond grain size that is the same or similar to any diamond particle sizes and distributions disclosed herein. More details about diamond particle sizes and diamond particle size distributions that may be employed are disclosed in U.S. Pat. No. 9,346,149, the disclosure of which is incorporated by reference herein in its entirety.

In some embodiments, the diamond grains of the resulting body 170 may exhibit an average grain size that is equal to or less than approximately 12 μm and include cobalt content of greater than about 7 weight percent (wt. %) cobalt. In some other embodiments, the diamond grains of the resulting body 170 may exhibit an average grain size that is equal to or greater than approximately 20 μm and include cobalt content of less than approximately 7 wt. %. In some embodiments, the diamond grains of the resulting body 170 may exhibit an average grains size that is approximately 10 μm to approximately 20 μm.

In some embodiments, bodies 170 may be sintered as PCD bodies at a pressure of at least about 7.5 GPa, may exhibit a coercivity of 115 Oe or more, a high-degree of diamond-to-diamond bonding, a specific magnetic saturation of about 15 G·cm³/g or less, and a metal-solvent catalyst content of about 7.5 wt. % or less. The PCD may include a plurality of diamond grains directly bonded together via diamond-to-diamond bonding to define a plurality of interstitial regions. At least a portion of the interstitial regions or, in some embodiments, substantially all of the interstitial regions may be occupied by a metal-solvent catalyst, such as iron, nickel, cobalt, or alloys of any of the foregoing metals. For example, the metal-solvent catalyst may be a cobalt-based material including at least 50 wt. % cobalt, such as a cobalt alloy.

The metal-solvent catalyst that occupies the interstitial regions may be present in the PCD in an amount of about 7.5 wt. % or less. In some embodiments, the metal-solvent catalyst may be present in the PCD in an amount of about 3 wt. % to about 7.5 wt. %, such as about 3 wt. % to about 6 wt. %. In other embodiments, the metal-solvent catalyst content may be present in the PCD in an amount less than about 3 wt. %, such as about 1 wt. % to about 3 wt. % or a residual amount to about 1 wt. %. By maintaining the metal-solvent catalyst content below about 7.5 wt. %, the PCD may exhibit a desirable level of thermal stability.

Generally, as the sintering pressure that is used to form the PCD increases, the coercivity may increase and the magnetic saturation may decrease. The PCD defined collectively by the bonded diamond grains and the metal-solvent catalyst may exhibit a coercivity of about 115 Oe or more and a metal-solvent catalyst content of less than about 7.5 wt. % as indicated by a specific magnetic saturation of about 15 G·cm³/g or less. In a more detailed embodiment, the coercivity of the PCD may be about 115 Oe to about 250 Oe and the specific magnetic saturation of the PCD may be greater than 0 G·cm³/g to about 22 G·cm³/g. In an even more detailed embodiment, the coercivity of the PCD may be about 115 Oe to about 175 Oe and the specific magnetic saturation of the PCD may be about 5 G·cm³/g to about 22 G·cm³/g. In yet an even more detailed embodiment, the coercivity of the PCD may be about 155 Oe to about 175 Oe and the specific magnetic saturation of the PCD may be about 10 G·cm³/g to about 22 G·cm³/g. The specific permeability (i.e., the ratio of specific magnetic saturation to coercivity) of the PCD may be about 0.10 or less, such as about 0.060 to about 0.090. Despite the average grain size of the bonded diamond grains being less than about 30 μm, the metal-solvent catalyst content in the PCD may be less than about 7.5 wt. % resulting in a desirable thermal stability.

In an embodiment, diamond particles having an average particle size of about 18 μm to about 20 μm are positioned adjacent to a cobalt-cemented tungsten carbide substrate and subjected to an HPHT process at a temperature of about 1390° C. to about 1430° C. and a cell pressure of about 7.8 GPa to about 8.5 GPa. The PCD so-formed as a PCD body 170 may exhibit a coercivity of about 155 Oe to about 175 Oe, a specific magnetic saturation of about 10 G·cm³/g to about 15 G·cm³/g, and a cobalt content of about 5 wt. % to about 7.5 wt. %.

In one or more embodiments, a specific magnetic saturation constant for the metal-solvent catalyst in the PCD may be about 185 G·cm³/g to about 215 G·cm³/g. For example, the specific magnetic saturation constant for the metal-solvent catalyst in the PCD may be about 195 G·cm³/g to about 205 G·cm³/g. It is noted that the specific magnetic saturation constant for the metal-solvent catalyst in the PCD may be composition dependent.

Generally, as the sintering pressure is increased above 7.5 GPa, a wear resistance of the PCD so-formed may increase. For example, the Gᵣₐₜᵢₒ may be at least about 4.0×10⁶, such as about 5.0×10⁶ to about 15.0×10⁶ or, more particularly, about 8.0×10⁶ to about 15.0×10⁶. In some embodiments, the Gᵣₐₜᵢₒ may be at least about 30.0×10⁶. The Gᵣₐₜᵢₒ is the ratio of the volume of work piece cut (e.g., between about 470 in³ of barre granite to about 940 in³ of barre granite) to the volume of PCD worn away during the cutting process. It is noted that while such a process may involve a so-called “granite log test,” this process is still applicable for determining the Gᵣₐₜᵢₒ of the PCD even though the cutter may be intended for use in metal cutting processes rather than rock cutting or drilling.

The material characteristics discussed herein, as well as other characteristics that may be provided in a polycrystalline diamond element 152, including processes for measuring and determining such characteristics, as well as methods of making such cutting elements, are described in U.S. Pat. Nos. 7,866,418, 8,297,382, and U.S. U.S. Pat. No. 9,315,881, the disclosure of each of which is incorporated by reference herein in its entirety.

In some embodiments, the body 170 may comprise high density polycrystalline diamond. For example, in some embodiments, the body 170 may comprise approximately 95 percent diamond by volume (vol. %) or greater. In some embodiments, the body 170 may comprise approximately 98 vol. % diamond or greater. In some embodiments, the body 170 may comprise approximately 99 vol. % diamond or greater. In other embodiments, the body 170 may comprise polycrystalline diamond or relatively low diamond content. For example, in some embodiments, the body 170 may comprise less than 95 percent diamond by volume (vol. %).

In some embodiments, the body 170 may be integrally formed with a substrate. In some other embodiments, the body 170 may be a pre-formed body that has been HPHT bonded to a substrate in a second HPHT process after being initially formed in a first HPHT process. For example, the body 170 may be a pre-formed PCD body that has been leached to substantially completely remove the metal-solvent catalyst used in the manufacture thereof and subsequently HPHT bonded or brazed to the substrate in a separate process.

The substrate may be formed from any number of different materials, and may be integrally formed with, or otherwise bonded or connected to, the body 170. Materials suitable for the substrate may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof.

However, in some embodiments, the substrate may be omitted and the polycrystalline diamond body 170 may be leached to deplete the metal-solvent catalyst therefrom or may be an un-leached PCD body. As discussed above, in some embodiments, the body 170 may be leached to deplete a metal-solvent catalyst or a metallic infiltrant therefrom in order to enhance the thermal stability of the body 170. For example, the body 170 may be leached to remove at least a portion of the metal-solvent catalyst that was used to initially sinter the diamond grains to form a leached thermally-stable region from a working region thereof to a selected depth. The leached thermally-stable region may extend inwardly from a working surface to a selected depth. In some embodiments, the working surface may be either an exterior surface (e.g. top surface 172 or bottom surface 173) or an interior surface, such as a surface of opening 180 or a surface of at least one leaching feature 184 described in greater detail below. In an embodiment, the depth of the thermally-stable region may be about 50 μm to about 1,500 μm. More specifically, in some embodiments, the selected depth is about 50 μm to about 900 μm, about 200 μm to about 600 μm, or about 600 μm to about 1200 μm. The leaching may occur by exposing the PCD to a suitable acid, such as aqua regia, nitric acid, hydrofluoric acid, or mixtures of the foregoing.

As depicted in FIGS. 3-10, the polycrystalline diamond elements 152 may be configured to exhibit a substantially square outer profile, a rounded square outer profile, and/or a substantially rounded square outer profile when viewed from above (i.e., as seen specifically in FIG. 5). Such a geometry provides multiple cutting edges 160A-160D which may be indexed relative to a cutting tool body 150 for extended service of the polycrystalline diamond elements 152. However, it is noted that other shapes and outer profiles are contemplated including, for example, generally circular, generally curved, generally triangular, generally hexagonal, generally octagonal, and other generally regular or generally irregular polygons.

As seen in FIGS. 5 and 6, the polycrystalline diamond elements 152 may also include an opening 180 formed in the body 170 and substrate (not shown) to accommodate a fastener for coupling of the cutting element 152 with a cutting tool body 150. The opening 180 may include a countersunk region 182 (or a counter bore, depending on the type of fastener being used) to enable a fastener to be positioned flush with or below the top surface 172 of the body 170 when the cutting element 152 is coupled with a cutting tool body 150. The opening 180 may be centered within the table and extend through the table.

The polycrystalline diamond element 152 may include a cutting tool insert 154. FIG. 5 is a lower perspective view of the cutting tool insert 154 according to an embodiment of the present disclosure and FIG. 6 is an upper perspective view of the cutting tool insert 154. The cutting tool insert 154 may include the body 170 having a top surface 172, a bottom surface 173, and a fastener hole (e.g., opening 180) extending through the center of the body 170 from the top surface 172 to the bottom surface 173. The cutting tool insert 154 may include at least one leaching feature 184 defined by or included by a portion of the body 170. The at least one leaching feature 184 may reduce the cross-sectional area of the body 170.

Generally, one aspect of the present disclosure relates to at least one leaching feature 184 that facilitates removal of an interstitial material from the polycrystalline diamond body. In one example, at least one leaching feature 184 may facilitate leaching of an interstitial material from a polycrystalline diamond body by reducing the time required to remove the interstitial material to a selected depth/amount (i.e., reducing a leaching cycle time) and/or by increasing the extent to which the interstitial material is removed. In some embodiments, at least one leaching feature 184 may include an off-center hole extending from the top surface 172 of the cutting tool insert 154 and into the body 170 as shown in FIG. 5. Off-center may include any feature location that is not directly in the center of the body 170 of the cutting tool insert 154. The leaching feature 184 includes at least one off-center hole (e.g., a through hole or a blind hole, without limitation) or recess within the polycrystalline diamond body. The leaching feature 184 is configured to reduce the leaching cycle time of the at least one interstitial constituent (e.g., the metal-solvent catalyst). In some embodiments, the leaching cycle time may include the time required to remove the interstitial material to a selected depth/amount. At least one metal-solvent catalyst is present in at least some interstitial regions of the polycrystalline diamond and the leaching feature 184 is configured to facilitate removal of the metal-solvent catalyst. The leaching feature 184 may reduce the leach rate significantly by providing access to regions that would otherwise be arduous to reach by diffusion and/or more surface area contact for the acid and allowing the acid to more quickly remove the metal-solvent catalyst, particularly in areas having large cross-sections. As shown in FIG. 5, the leaching feature 184 may include a plurality of holes spaced at least one of radially and/or circumferentially from each other. The plurality of holes may be partially defined by rib structures 186 disposed between adjacent holes. The rib structure 186 may strengthen the cutting tool insert 154 and may provide more surface area exposed to the leaching agent and may also provide a reduced cross-section area. As shown in FIG. 6, the leaching feature 184 may include a recess on the bottom surface 173 of the body 170. The recess may be an off-center blind hole extending into the polycrystalline diamond body from any surface of the cutting tool insert 154. The recess may include a plurality of recesses on any surface of the cutting tool insert 154.

FIG. 7 is a lower perspective view of a cutting tool insert 154 according to one embodiment and FIGS. 8 and 9 are cross-sectional views of a cutting tool insert 154. The cutting tool insert 154 includes at least one leaching feature 184. The at least one leaching feature 184 may include an off-center hole. In some embodiments, the off-center hole extends through the cutting tool insert 154 from the top surface 172 to the bottom surface 173. The at least one leaching feature 184 may extend through a thickness of the polycrystalline diamond body 170. In some embodiments, the cutting tool insert 154 may include a plurality of leaching features 184 (e.g., off-center holes). The plurality of holes may be spaced at least one of radially and/or circumferentially from each other. The plurality of leaching features 184 may include any number of holes greater than one and may be separated from each other by reinforcement ribs and/or other structural features.

The leaching feature 184 may include unique geometries as it extends through the cutting tool insert 154. As shown in FIG. 7, the leaching feature 184 includes a plurality of off-center holes having a conical shape. In other words, a diameter of the off-center hole is greater at the top surface 172 of the cutting tool insert 154 than a diameter of the off-center hole at the bottom surface 173. In other embodiments, a leaching feature 184 may include or define an hourglass shape, where a diameter may be smallest at a center point cross-section of the body 170 and largest at the top and/or bottom surface 172, 173.

FIGS. 8 and 9 are cross-sectional views of an example cutting tool insert 154. The cross-section view is taken along a plane parallel to a top and/or bottom surface of the cutting tool insert 154. The cross-sectional area of the cutting tool insert 154 may be defined as the area of a two-dimensional shape that is obtained when the three-dimensional cutting tool insert 154 is sliced perpendicular to the specified axis passing through the top and bottom surface of the cutting tool insert 154 at a point between the top and bottom surface of the cutting tool insert 154. FIGS. 8 and 9 show a plurality of leaching features 184, each of which may include a generally semi-circular or semi-elliptical shape. The leaching features 184 shown in FIG. 8 and FIG. 9 may extend completely through the body 170 of the cutting tool insert 154. The leaching features 184 may be configured to allow a coolant to pass through the cutting tool insert 154 during use in cutting a work piece. The off-center holes may allow coolant to contact the surface area of the cutting tool insert 154 to allow more thermal transfer from the cutting tool insert 154 to the coolant as compared with a cutting tool insert without any such leaching features.

Various methods may be employed to form the at least one leaching feature 184, opening 180, or other geometric features, including processes such as grinding, electro-discharge machining, electro-discharge grinding, honing, lapping, laser machining, laser cutting, combinations of the foregoing, and/or any other suitable process. Some non-limiting methods of forming such features in the cutting element are described in U.S. Pat. Nos. 9,089,900, 9,062,505, and PCT Patent Application No. PCT/US2018/013069 (entitled ENERGY MACHINED POLYCRSTALLINE DIAMOND COMPACTS AND RELATED METHODS, filed on Jan. 10, 2018, attorney docket number 260249WO01_480566-426), the disclosure of each of which documents is incorporated by reference herein in its entirety.

FIG. 10 is a side view of a polycrystalline diamond element insert blank 188 being formed into a cutting tool insert 154 according to an embodiment of the present disclosure. In some embodiments, at least a portion of the cutting tool insert 154 may be formed by laser ablation. A method of forming the cutting tool insert 154 may include providing a polycrystalline diamond body 198 having an exterior surface 200, wherein the body 198 includes a plurality of bonded diamond grains defining a plurality of interstitial regions. The method of forming the cutting tool insert 154 may further include applying laser energy having a beam 202 focused on the exterior surface 200 of the table to remove a portion of the polycrystalline diamond body 198. In one example, laser ablation of the polycrystalline diamond body 198 may occur in a layered, concentric pattern. As shown in FIG. 10, the region 190 is the area removed by the beam 202 through layered ablation. Alternative patterns or any suitable laser ablation process are also contemplated.

In some embodiments, applying laser energy having a beam 202 focused on the exterior surface 200 of the body 198 comprises applying laser energy that removes portions of the polycrystalline diamond body 198 in a shape pattern. The pattern shape may include an inverse of the cutting tool insert 154. Shape patterns occur when a group of shapes are repeated over and over again. These patterns follow a certain sequence, or order, of shapes that is then repeated at least two times. In other words, the beam 202 removes a portion of the exterior surface 200 such that the cutting tool insert 154 is formed. Laser energy is applied to a peripheral portion of an exterior surface 200 of a cutting tool insert 154 to remove diamond material from the peripheral portion to form the polycrystalline diamond body 198 having a selected geometry. The portions of the polycrystalline diamond body 198 that are adjacent to the peripheral portion of the body 198 (i.e., that portion that is removed) may also be removed by any suitable technique (e.g., laser cutting, grinding, lapping, electrical-discharge machining, or combinations thereof) to result in a polycrystalline diamond body 198 having a selected geometry, such as a non-cylindrical or a generally cylindrical geometry. For example, this method may be used to form polycrystalline diamond tables 198 having oval, square, rectangular, or other shaped profile.

Referring now to FIGS. 11A-11C, in some embodiments, laser energy may be applied to the exterior surface 200 of a provided polycrystalline diamond element insert blank 188 to form the polycrystalline diamond body 198 in a series of passes of the laser concentric to each other so that the diamond material is removed to a first depth in a first pass from an upper surface of the polycrystalline diamond body 198. In other words, the laser energy removes diamond material to a first depth from the upper surface of the polycrystalline diamond table to form a portion of at least one annular or congruent groove in the upper surface of the polycrystalline diamond table, as depicted in FIG. 11B. The region 190 is the area removed from the insert blank 188 by the beam 202 through layered ablation. The laser energy may be applied generally parallel to the exterior surface 200 of the polycrystalline diamond body 198. The laser energy may be adjusted by moving the polycrystalline diamond body 198 toward a scan head of the laser. Applying the laser energy to at least one subsequent pass thereafter removes diamond material adjacent to and at a depth greater than the diamond material removed in the immediately previous pass of the laser beam 202. As such another portion of the at least one annular or congruent groove is formed in the upper surface of the polycrystalline diamond body 198. The at least one annular or congruent groove may be partially defined by at least one tapered sidewall 204.

Such progressive formation of the laser cut in the polycrystalline diamond body 198 may prevent or reduce thermal damage to the polycrystalline diamond body 198 as the depth of material removed in each pass is sufficiently low so as to substantially reduce overheating or damage to adjacent diamond material. For example, such progressive cutting patterns may inhibit back conversion of diamond to graphite or amorphous carbon that may otherwise result where heat from the laser cutting is absorbed too rapidly into adjacent diamond material.

Multiple passes, particularly when separated by rest periods, allow the heat to dissipate, resulting in an overall lower temperature within the material adjacent to the pattern being laser cut. Although such methods may allow for high quality geometrical control while minimizing damage, in alternative embodiments, the diamond material may be cut to a desired depth in a single pass or cut. In some embodiments, the pattern may include a series of closed loops (e.g., concentric closed loops or congruent closed loops). A concentric pattern may provide a relatively consistent cutting edge for the cutting tool insert 154. The edge may be formed straighter and formed without inclusions or defects.

Referring to FIG. 11C, progressive layers of the diamond material may be ablated away by adjusting the laser toolpath in reference to the cutting tool insert 154 such that each subsequent layer forms a desired angle (α) on the insert 154. Applying the laser energy with the beam 202 may include directing the laser beam 202 generally parallel to the exterior surface of the body 198. In some embodiments, applying laser energy includes adjusting a focus of the laser beam 202 by moving the polycrystalline diamond body 198 toward a scan head of the laser. The scan head includes the source of the laser beam 202. Therefore, the tapered sidewall 204 may be formed. In some embodiments, each of the subsequent passes of the laser removes a successive depth (δₕ) of about 0.00025 inch to about 0.002 inch of diamond material as a cut is progressively formed. The laser forms a first groove by focusing the laser beam 202 on a portion of the body 198. In other words, a concentric level 206 is formed as the laser beam 202 is focused on the surface of the insert 154. A second concentric level 208 or groove may be formed with a subsequent pass of the laser. Several other concentric levels, 210, 212, 214, 216, 218, and 220 as shown in FIG. 11C below level 208, are then formed by layered ablation. Each concentric level of the tapered sidewall 204 may include a width (δ_{w}) either greater than or less than the depth, depending on the desired angle (α) of the tapered sidewall 204. In some embodiments, applying laser energy having the beam 202 focused on the exterior surface 200 of the polycrystalline diamond body 198 to remove portions of the diamond material adjacent to the exterior surface 200 by layered ablation of the polycrystalline diamond material comprises forming at least one leaching feature (e.g., leaching feature 184) configured to reduce leaching cycle time and/or facilitate removal of at least one interstitial material.

Additionally, the polycrystalline diamond elements 152 may be subjected to other methods for laser cutting or emitting a plurality of energy beams or pulses to form polycrystalline diamond structures. Examples of laser ablation and/or cutting methods that may be used to form the leaching features and/or any feature described herein are described in U.S. Pat. No. 9,062,505, the disclosure of which is incorporated by reference herein in its entirety. Examples of machining polycrystalline diamond structures by emitting energy beams that may be used to form the leaching features and/or any feature described herein are described in PCT Patent Application No. PCT/US2018/013069 (entitled ENERGY MACHINED POLYCRSTALLINE DIAMOND COMPACTS AND RELATED METHODS, filed on Jan. 10, 2018, attorney docket number 260249WO01_480566-426) the disclosure of each of which documents is incorporated by reference herein in its entirety.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”).

1. A polycrystalline diamond element, comprising:
a polycrystalline diamond body including a plurality of bonded diamond grain defining a plurality of interstitial regions, at least some of the plurality of interstitial regions at least partially occupied and/or previously occupied by at least one interstitial constituent, the polycrystalline diamond table including a top surface and a bottom surface opposite the top surface; and
a plurality of off-center leaching features defined by the polycrystalline diamond body positioned and configured to facilitate leaching of the at least one interstitial constituent, the plurality of off-center leaching features including a plurality of holes defined by the polycrystalline diamond body extending from at least one of the top surface or the bottom surface, each of the plurality of holes extending from the top surface or the bottom surface are circumferentially spaced from each other.

2. The polycrystalline diamond element of claim 1, wherein the polycrystalline diamond element is configured as at least one of a bearing or a cutting tool insert.

3. The polycrystalline diamond element of claim 1, wherein at least one of the plurality of holes extends completely through a thickness of the polycrystalline diamond body.

4. The polycrystalline diamond element of claim 1, wherein at least one of the plurality holeses extend partially into the polycrystalline diamond body from a surface thereof.

5. (canceled)

6. The polycrystalline diamond element of claim 1, wherein the plurality of holes are configured to allow a coolant to pass through the polycrystalline diamond element.

7. A cutting tool insert, comprising:
a polycrystalline diamond body including a plurality of bonded diamond grain defining a plurality of interstitial regions, at least some of the plurality of interstitial regions at least partially occupied and/or previously occupied by at least one interstitial constituent, the polycrystalline diamond table including a top surface and a bottom surface opposite the top surface; and
a plurality of off-center leaching features defined by a portion of the polycrystalline diamond body, wherein the leaching feature reduces a cross-sectional area of the polycrystalline diamond body to reduce leaching cycle time of the at least one interstitial constituent, the plurality of off-center leaching features including a plurality of holes defined by the polycrystalline diamond body extending from at least one of the top surface or the bottom surface, each of the plurality of holes extending from the top surface or the bottom surface are circumferentially spaced from each other.

8. The cutting tool insert of claim 7, wherein at least one of the plurality of hole extends from the top surface into the polycrystalline diamond body.

9. The cutting tool insert of claim 7, wherein at least one of the plurality of holes extends through the polycrystalline diamond body from the top surface to the bottom surface of the polycrystalline diamond body.

10. The cutting tool insert of claim 7, wherein at least one of the plurality of holes extends from the bottom surface partially into the polycrystalline diamond body.

11. The cutting tool insert of claim 7, wherein at least some of the plurality of interstitial regions of the polycrystalline diamond table include at least one metal-solvent catalyst therein, and the at least one leaching feature is configured to facilitate removal of the metal-solvent catalyst.

12. The cutting tool insert of claim 7, wherein the plurality of holes are spaced circumferentially from each other with rib structures disposed between the plurality of holes.

13. The cutting tool insert of claim 7, wherein the polycrystalline diamond body includes a cutting edge formed from a series of loops arranged concentrically around a periphery of the polycrystalline diamond body, the periphery exhibiting a tapered shape and extending from or near the top surface to or near the bottom surface.

14. A method of forming a cutting tool insert, the method comprising:
providing a polycrystalline diamond body having an exterior surface including a top surface and a bottom surface opposite the top surface, wherein the polycrystalline diamond body includes a plurality of bonded diamond grains defining a plurality of interstitial regions; and
applying laser energy with a laser to the polycrystalline diamond body effective to remove a portion of the polycrystalline diamond body by layered ablation of the polycrystalline diamond body, wherein applying laser energy to the polycrystalline diamond body includes forming a plurality of off-center leaching features including a plurality of holes defined by the polycrystalline diamond body extending from at least one of the top surface or the bottom surface, each of the plurality of holes extending from the top surface or the bottom surface are circumferentially spaced from each other.

15. The method of claim 14, wherein applying laser energy to the polycrystalline diamond body includes applying laser energy that removes portions of the polycrystalline diamond body in a pattern shape.

16. The method of claim 15, wherein the pattern shape includes a series of closed loops.

17. The method of claim 14, wherein applying laser energy includes adjusting a focus of the laser energy by moving the polycrystalline diamond body toward a scan head of the laser.

18. The method of claim 14, further comprising applying laser energy in a first pass to an upper surface of the polycrystalline diamond body to remove diamond material to a first depth from the upper surface of the polycrystalline diamond body to form a portion of at least one groove in the upper surface of the polycrystalline diamond body; and
applying laser energy in at least one subsequent pass to remove exposed diamond material adjacent to and at a successive depth greater than the diamond material removed in an immediately previous pass to form another portion of the at least one groove in the upper surface of the polycrystalline diamond body, wherein the at least one groove is partially defined by at least one tapered sidewall.

19. The method of claim 18, wherein each of the subsequent passes of the laser removes a successive depth of about 0.00025 inch to about 0.002 inch of diamond material.

20. (canceled)

21. The polycrystalline diamond element of claim 3, wherein the polycrystalline diamond element does not include a substrate.

22. The polycrystalline diamond element of claim 1, wherein the polycrystalline diamond body defines a centrally positioned opening extending from the top surface to the bottom surface.
